(19) United States
(12) Patent Application Publication
(10) Pub. No.: US 2026/0246323 A1
(43) Pub. Date: Aug. 20, 2026

(54) METHOD FOR MANUFACTURING AN ARMATURE AND/OR ROTOR, AS WELL AS ARMATURE AND/OR ROTOR AND ELECTRIC MACHINE

(71) Applicant: ADDITIVE | DRIVES GMBH, Dresden (DE)

(72) Inventor: Axel HELM, Dresden (DE)

(21) Appl. No.: 19/152,777

(22) PCT Filed: Jan. 10, 2024
(86) PCT No.: PCT/EP2024/050457

§ 371 Date: Jul. 31, 2025

(30) Foreign Application Priority Data
Feb. 9, 2023 (DE) 10 2023 103 204.6

(51) Int. Cl. H02K 1/26; H02K 1/32; H02K 11/21; H02K 15/023; H02K 15/0646; H02K 17/16

(52) U.S. Cl. CPC H02K 1/26; H02K 1/32; H02K 11/21; H02K 15/023; H02K 15/0646; H02K 17/168

(57) ABSTRACT

Disclosed is a method for manufacturing an armature and/or rotor for an electric machine, including inserting slot bars into slots extending in an axial direction of a laminate stack such that the slot bars have a protrusion beyond the laminate stack at at least one of their end faces, and additively applying at least one ring on the at least one of the end faces of the slot bars. Further disclosed are an armature and/or rotor as well as an electric machine.

The invention relates to a method for manufacturing an armature and/or rotor, in particular a short circuit or cage rotor, for an electric machine, as well as a corresponding armature or rotor.

Methods for manufacturing an armature or rotor for an electric machine are generally known.

The known methods for manufacturing an armature or rotor are considered to be fundamentally in need of improvement. In particular, the known methods, for example, forming processes, are considered to be comparatively complex, especially due to the type, number and/or scope of pressure die casting and/or injection moulding tools required, and/or they do not meet the requirements placed on the armature, in particular with regard to installation space, thermal and/or electrical properties and/or material quality, in the desired manner.

Primary forming is a main group of manufacturing processes and, according to DIN 8580, combines all manufacturing processes in which a solid body with a geometrically defined shape is produced from a formless material.

In general, the object in the context of armatures and/or rotors is to further optimise their parameters, in particular with regard to installation space, thermal and/or electrical properties, and to make them flexible. This is also due to the fact that electric motors are being used more widely, in particular when they can better meet the requirements placed on them, such as energy efficiency, flexibility and/or a limitation and/or reduction of the installation space required.

In particular, a rapid and/or flexible provision of armatures and/or rotors with modified properties is also an object that is increasingly arising or may arise in the manufacture of armatures and/or rotors.

In particular, it is an object of the invention to reduce the type, number and/or scope of pressure die-casting and/or injection moulding tools required for the manufacture of an armature and/or rotor.

In particular, it is an object of the invention to adapt and/or improve the underlying primary forming processes with regard to improved material properties of the armature and/or rotor.

In particular, it is an object of the invention to improve or optimise the cooling structure of an armature and/or rotor.

It is therefore object of the invention to propose a method for manufacturing an armature and/or rotor for an electric machine, in particular an electric motor or generator, wherein the manufacturing effort is to be as low as possible and/or the manufacturing is to be as flexibly adaptable as possible and/or a comparatively high efficiency and/or good usability of the armature and/or rotor or a corresponding electric machine in operation is to be achieved.

In particular, it is an object of the invention to reduce the thermal and/or electrical power loss in the armature and/or rotor and/or to reduce and/or minimise the required installation space for the armature.

At least one of these objects is solved by the subject matter according to claim 1.

In particular, the at least one object is solved by a method for manufacturing an armatures and/or rotor, in particular a short circuit or cage rotor, for an electric machine, comprising the method steps
inserting slot bars, in particular produced by an additive process, machining, extrusion or die casting, into slots, in particular extending in an axial direction, of a laminate stack, so that the slot bars have at least one protrusion beyond the laminate stack at at least at one of their end faces, in particular at the height of at least one insert, or are flush with the laminate stack,
additively applying, in particular printing, of at least one ring, preferably a short-circuit ring, to at least one of the end faces of the slot bars, in particular by means of an additive printing process.

The invention enables, in particular, a fast, improved and/or flexible provision of an armature and/or rotor. In particular, no die-casting and/or injection-moulding tool is required to manufacture the armature and/or rotor according to the invention. In particular, the material properties of the armature and/or rotor are improved.

In particular, a first ring is applied to first end faces of the slot bars and a second ring is applied to second end faces of the slot bars opposite the first end faces.

Preferably, the slot bars and/or the at least one ring are free of pores and/or cavities. In particular, the slot bars and/or the at least one ring have a porosity or residual porosity of less than 0.1%. In particular, the slot bars and/or the at least one ring have a porosity or residual porosity in a range from 0.01% to 0.1%. The porosity or residual porosity refers in particular to the ratio of the volume of all cavities of the slot bars and/or the at least one ring to their/its external volume. This enables in particular an improved conductivity. In contrast, slot bars and/or rings produced by die casting usually have cavities and/or pores, which results in poorer conductivity. Preferably, at least one, in particular at least partially circumferential, air gap and/or air inclusion is arranged between the slot bars and the slots, in particular the laminate stack. Preferably, no full-surface contact is established between the slot bars and the slots, in particular the laminate stack.

In particular, air gaps and/or air inclusions extend at least partially around the inserted slot bars to the laminate stack.

Preferably, the at least one, in particular at least partially circumferential, air gap and/or air inclusion has an insulating effect and/or reduces electrical losses. In contrast, slot bars produced by die casting generally do not have air gaps and/or air inclusions, which increases or can increase electrical losses.

An axial direction is understood in particular to mean a direction parallel to an axis of the armature or rotor, in particular a direction parallel to one or the axis of rotation of the armature or rotor.

A slot is understood in particular to be a through hole in the laminate stack, in particular at a slot angle to an axial direction. The slots are arranged in particular next to one another in the circumferential direction in the laminate stack, preferably at equal distances in the circumferential direction and/or at equal distance from the axis of rotation of the armature or rotor.

In one embodiment, a laminate stack comprises laminated and electrically insulated sheets which are stacked on top of one another and joined together. Preferably, the sheets or sheet laminations are separated from one another by electrically insulating layers in order to reduce or prevent eddy current losses.

In one embodiment, the rotor or armature, in particular the short circuit or cage rotor, forms permanently short-circuited solid windings in the form of a cage in the laminate stack, in particular by means of the rings connected to the slot bars. Preferably, the rings produce an electrical short circuit between the slot bars.

In one embodiment, the invention comprises a method for manufacturing an armature and/or rotor, in particular a short-circuit or cage rotor, for an electric machine, further comprising the method steps, in particular before the additive application, in particular printing, of the at least one ring,
attaching the at least one insert to an end face of the laminate stack, in particular as a joining aid and/or for thermal and/or electrical insulation,
joining the at least one insert, in particular by means of a temperature-stable adhesive, to the laminate stack, wherein in particular at least one essentially flat surface is produced between an end face of the slot bars and a surface of the at least one insert, wherein the at least one essentially flat surface is preferably produced by machining methods and/or by precision manufacturing of the laminate stack, insert and slot bars.

In particular, the at least one object is solved by an armature and/or rotor, in particular a short-circuit or cage rotor, for an electric machine, manufactured according to a method according to the invention.

In particular, the at least one object is solved by an armature and/or rotor, in particular a short-circuit or cage rotor, for an electric machine, in particular manufactured according to a method according to the invention, comprising a laminate stack,
wherein slot bars are inserted into the laminate stack in such a way that the slot bars have a protrusion beyond the laminate stack at at least one of their end faces, in particular at the height of at least one insert which is attached or can be attached to an end face of the laminate stack, or are flush with the laminate stack,
wherein at least one ring, preferably a short-circuit ring, is additively applied to at least one of the end faces of the slot bars, in particular by means of an additive printing process.

In one embodiment, the ring is printed directly onto the laminate stack and/or onto the slot bars.

In one embodiment, the slot bars are produced by an additive process, machining, extrusion and/or die casting.

In one embodiment, the ring is printed on the laminate stack and/or on the slot bars on its underside, flush or in the form of arcs and/or bridges between the end faces of the slot bars.

In one embodiment, the ring comprises blades for putting a coolant into circulation, which extend from an outer circumference of the ring to an inner circumference, in particular running arcuately and/or curvedly from the outer circumference of the ring to an inner circumference.

In one embodiment, the blades have a curvature in axial and/or radial direction.

In one embodiment, first cooling channels extend through the laminate stack.

In one embodiment, second cooling channels extend through the slot bars.

In one embodiment, the blades are printed onto the slot bars in such a way that the cooling channels continue through, at and/or between the blades in the axial direction.

In one embodiment, the ring comprises at least one sensor for determining the position, in particular of a rotational angle of the armature and/or rotor.

By the method according to the invention, in particular, the thermal and/or electrical power loss in the armature can be reduced and/or the installation space for the armature and/or rotor can be reduced and/or minimised. In addition, a fast, flexible and efficient production is possible.

An additive application or manufacturing in particular is understood to be the manufacture by means of 3D printing, in particular 3D copper printing, and/or by means of an additive printing process and/or a primary forming process. The elements and/or connections of the armature, in particular the ring or rings and/or the slot bars, are therefore preferably manufactured in one piece and directly in their final form, in particular by layer-by-layer application of build-up material and preferably selective solidification, preferably by means of a beam impinging thereon, for example a laser beam.

Additive application is therefore preferably understood to mean the layer-by-layer application of a component to an existing, prefabricated component without the use of welded joints, in particular without the use of welded joints between two or more prefabricated components, and/or forming tools and/or tools in general. A layer-by-layer application means, in particular, the creation or manufacture of a component by layer-by-layer application to an existing other component.

The additive application is preferably carried out based on data sets that define the respective geometries. These data sets are preferably generated during design and/or by a CAD or CAE program. These data sets then control a 3D printing system which additively, in particular layer by layer, applies the build-up material and preferably selectively solidifies it, and thereby preferably produces at least one section of the slots, of the at least one ring and/or of the laminate stack.

The additive application may also comprise (or not comprise): a material application process, in particular build-up welding, preferably wire and/or copper build-up welding and/or arc build-up welding, and/or a spray application process, in particular cold spray application process. By this, in a simple manner, possibly only slightly complex geometries may be produced. In one embodiment, the armature and/or rotor is manufactured in a two-stage process.

In one embodiment, the armature and/or rotor is manufactured in a three-stage process.

In particular, the at least one object is solved by a method for manufacturing an armature and/or rotor, in particular a short-circuit or cage rotor, for an electric machine, comprising the method steps
inserting slot bars, in particular produced by an additive process, machining, extrusion or die casting, into slots, in particular extending in an axial direction, of a laminate stack, so that the slot bars have a protrusion beyond the laminate stack at both end faces, in particular at the height of two inserts, or are flush with the laminate stack,
additively applying, in particular printing, of a first ring, preferably a short-circuit ring, onto a first end face of the slot bars, in particular by means of an additive printing process,
additively applying, in particular printing, of a second ring, preferably a short-circuit ring, onto a second end face of the slot bars opposite the first end face, in particular by means of an additive printing process.

In particular, the at least one object is solved by a method for manufacturing an armature and/or rotor, in particular a short-circuit or cage rotor, for an electric machine, comprising the method steps
inserting slot bars, in particular produced by an additive process, machining, extrusion or die casting, into slots, in particular extending in an axial direction, of a laminate stack, so that the slot bars have a protrusion beyond the laminate stack at a first end face and at a second end face opposite the first end face, in particular at the height of an insert each,
attaching one insert to each of the end faces of the laminate stack, in particular as a joining aid and/or for thermal and/or electrical insulation,
joining the inserts, in particular by means of a temperature-stable adhesive, to the laminate stack, wherein in particular two essentially flat surfaces are produced between the end faces of the slot bars and a respective surface of the inserts, wherein the two essentially flat surfaces are preferably produced by machining methods and/or by precision manufacturing of the laminate stack, inserts and slot bars,
additively applying, in particular printing, of a first ring, preferably a first short-circuit ring, to the first end face of the slot bars, in particular by means of an additive printing process,
additively applying, in particular printing, of a second ring, preferably a second short-circuit ring, to the second end face of the slot bars opposite the first end face, in particular by means of an additive printing process.

In particular, the at least one object is solved by a method for manufacturing an armature and/or rotor, in particular a short-circuit or cage rotor, for an electric machine, comprising the method steps
inserting slot bars, in particular produced by an additive method, machining, extruding or die-casting, into slots, in particular extending in an axial direction, of a laminate stack, so that the slot bars have a protrusion beyond the laminate stack at one of their end faces, in particular at the height of an insert, or are flush with the laminate stack, wherein the slot bars are in particular U-shaped,
additively applying, in particular printing, of a ring, preferably a short-circuit ring, to one of the end faces of the slot bars, in particular by means of an additive printing process.

In particular, in the first stage, the active area of the armature is produced with the laminate stack and its slot bars. Thus, in the first stage, the armature laminate stack with the slot bars is preferably produced and, for this purpose, the slot bars are inserted into the slots or also produced additively concomitantly with the laminate stack. In particular, the slot bars can be produced additively at least partially within the slots.

In the second stage, the, in particular first, ring, in particular the short-circuit ring, is then produced by additive application to the slot bars, whereby the slot bars can in particular be short-circuited with one another.

In one embodiment, both the first and second, in particular the first, second and third, stages of manufacturing the armature and/or rotor are carried out by an additive process or comprise such a process.

In one embodiment, both the first and second, in particular the first, second and third, stages of manufacturing the armature and/or rotor comprise an additive process, wherein in the first stage the slot bars are in particular additively manufactured, which are then inserted in the axial direction into the laminate stack. Alternatively, laminate stack and slot bars can also be manufactured together in an additive process.

One idea of the invention is to separate the production of the ring or rings, in particular the short-circuit ring, production-wise from the production of corresponding slot bars, on the one hand, and, on the other hand, to produce the ring by additive application (or an additive manufacturing process, for example laser sintering or laser melting), thereby improving the properties of the armature overall.

In particular, one idea of the invention is to manufacture at least one ring or even both rings in a separate process step and at least essentially without die casting, without injection moulding and without forming, in particular by direct application to the slot bars. By this, undesirable changes in wall thickness, springback, yield strains and/or material flow in the ring can be avoided or reduced, which would otherwise occur or could occur in particular by die casting, injection moulding or forming. In particular, bending in the, in particular upper, region of the armature is not necessary. In particular, twisting, bunching and/or twisting in the in particular upper and/or lower region of the armature and/or at the connection to the ring is not necessary.

The fact that bending and/or twisting in the, in particular upper, region of the armature is not necessary can also reduce manufacturing expenditures and time, while at the same time the disadvantages associated with bending and/or twisting in terms of tolerances in the course of connecting elements and the deterioration of conductivity are or can be reduced or avoided.

In addition, by additive application radii of connecting elements in the ring can be minimised or set to zero or almost zero, and/or cross-sections distances and/or layer jumps can be adjusted in a targeted and precise manner. Furthermore, tolerances during manufacturing are reduced, in particular with regard to the course and cross-sections of the connecting elements.

Another idea of the invention is to dispense with weld points and/or segmentations of the laminate stack. This can in particular improve the electrical and magnetic properties of the laminate stack and thus also of the electrical machine as a whole. For example, dispensing with weld points in the region of the ring, in particular for connecting the slot bars, can further improve the conductivity in the region of the ring.

In this case, the effects that can be achieved in conventional manufacturing, in particular without additive application, only by segmenting the laminate stack, i.e. by manufacturing the laminate stack in parts and subsequently joining them, are preferably retained. In particular, for example, the cross-section of the armature grooves within the laminate stack can vary in the radial and/or axial direction of the armature so that these have at least in part a smaller cross-section than the slot bars guided through them. In addition, transition points, for example connections, can be realised within the laminate stack, in particular within the slots, which require a larger cross-section than the remaining conductor parts.

The additive application makes it possible, in particular, to manufacture a further component, in particular the ring, in the same work step as well as at the same time connect it to the already existing components, in particular the slot bars.

In particular, additive application also enables the production of electrical connections between the slot bars and the ring as well as within the ring. Consequently, short-circuit connections between the slot bars are produced in particular by the additive application.

In particular, material changes and contact problems caused by die casting, injection moulding or welding can be reduced or avoided by means of additive application. At the same time, however, the flexibility to vary the slot bars, in particular with regard to their course and/or their cross-sections, remains and to combine them with the ring in a variable manner.

In particular, ‘injection moulding’ is understood to mean a primary forming process used in plastics and metal processing. In this process, the respective material is liquefied using an injection moulding machine and injected under pressure into a mould, the injection mould. In metal powder injection moulding, fine metal or ceramic powder is mixed with an organic binder and then shaped on an injection moulding machine. Subsequently, the binder is removed again and the component is sintered at a high temperature in a furnace. This requires high temperatures of up to 1600° C.

In particular, ‘die casting’ is understood to mean a casting process for series or mass production. Casting alloys with a low melting point are generally used for this purpose. In die casting, the liquid melt is pressed under high pressure of approx. 10 to 200 MPa and at a high mould filling speed of up to 12 m/s into a die casting mould, where it then solidifies. Temperatures of around 700° C. are therefore required for aluminium die casting.

In particular, in extrusion, a compact heated to a forming temperature, preferably a block or slab, is pressed through the opening of a die with a punch.

Consequently, injection moulding as well as die casting, and also extrusion, require moulds or tools that are costly to manufacture in terms of time, material and expense. In addition, the material must be brought to high temperatures, which can cause changes in the material.

Furthermore, in both injection moulding and die casting, the entire component is produced in one go, whereby the joining of different components is comparatively complex and not possible without more ado.

In particular, ‘welding’ is understood to mean the permanent joining of respective existing components, for example electrical conductors, using heat and/or pressure. In contrast, additive application is understood to mean in particular a layer-by-layer application of build-up material that is selectively solidified, in particular by means of a beam impinging thereon, for example a laser beam.

Preferably, ‘welding’ involves joining two already existing components, whereas in additive application, in particular, a second component is applied in layers to an existing first component and thus preferably newly created thereon, in particular on the basis of a control of the solidification by means of a data set. In this respect, ‘welding’ in this sense should especially not be understood as an additive manufacturing process. Build-up welding can be understood as an additive manufacturing process. Alternatively, build-up welding may be excluded.

Applications of the invention lie in particular in the area of prototyping and/or series production.

In particular, a combination of conventional manufacturing (e.g. by manufacturing from slot bars, which may or may not be formed, and additive manufacturing (e.g. by laser sintering or laser melting) is used.

In one embodiment, at least one or several or all of the slot bars are partially or completely not produced by an additive manufacturing process, preferably produced by forming a wire, in particular copper wire, and/or drawing from wire, in particular copper wire.

A (respective) slot bar can be inserted in such a way that the slot bar is already joined outside the slot and/or is not first built up in the slot.

Conventionally inserted armature blanks can preferably be interconnected by printing a ring (or both rings) onto them. In particular, slot bars can comprise mounted, cast and insulated (especially by means of primary insulation) conductors in an armature laminate stack.

The advantage of additively applying therefore lies in particular in the faster availability as well as the possibility of combining different manufacturing processes, and also in the lower heating of the material, which in additive application is preferably below 300° C., preferably below 250° C.

In particular, the slot bars can be I-shaped or U-shaped.

One and the same armature blank can, for example, be given different behaviour (e.g. with regard to torque and/or speed and/or cooling structure, etc.) by different designs of the rings.

For example, a first armature may comprise a first cooling structure and a second armature may comprise a second cooling structure differing from the first armature without the need to adapt a tool, in particular an injection moulding tool.

This makes it possible to develop a modular system that can produce a plurality of different electric motors on the basis of a armature blank (by combining the same armature blank with different printed rings). This different interconnection is preferably produced exclusively digitally in the design, in particular by variation of data sets for additive application, and/or without the use of physical tools. The data sets are preferably generated using a CAD or CAE program.

In addition, the slot bars can be specifically adapted, combined and/or varied in order, for example, to optimise the armature for a specific frequency behaviour.

In one embodiment, the cross-sectional areas of individual slot bars can also be maximised for low frequencies. For example, a slot can be divided into segments running next to each other in the axial direction, with the or each slot bar filling the respective segment at least essentially completely. Preferably, in this embodiment, the armature is provided for operating frequencies of a current through the slot bars of at most 10 KHz.

In one embodiment, for high frequencies, the cross-section of one or each slot bar can be divided into at least two or at least three partial cross-sections which are electrically insulated from one another, in particular in order to reduce the current displacement inside the conductor caused, for example, by skin effects, and thus to reduce the eddy current losses. In the embodiment, the rotor is preferably designed for operating frequencies of a current through the slot bars of at least 100 KHz.

Overall, a comparatively simple process is realised which nevertheless exploits (at least in part) the special advantages of an additive manufacturing step. In particular, the invention enables the following improvements in the manufacture of an armature and/or rotor, or can enable these:
Minimisation of installation space: In particular, the additive application of at least one ring or both rings enables a precise and/or compact application of the build-up material to the slot bars. Connecting elements as well as blade structures in the ring can be defined precisely or more precisely with low tolerances and/or distances with regard to their own course and their course relative to other connecting elements and blades.
Loss reduction: Electrical and/or thermal losses in the armature and/or rotor can preferably be reduced, since, in particular for connecting the ring, neither welding points, nor casting processes, nor segmentations of the laminate stack, nor bending or twisting processes are required. In addition, cross-sections can be specifically and precisely adjusted or increased at required locations in order to reduce current densities there or to adjust the coolant circulation. Furthermore, cross-sections can be adjusted to the frequencies prevailing in the armature.
Flexible use of slot bars: Different slot bars can be combined in the armature and/or rotor to specifically adapt the electrical and thermal properties to the existing parameters, for example operating frequencies or the requirement for cooling channels. In addition, different slot bars are flexibly interchangeable without having to change an injection moulding tool.

A first slot bar and a second slot bar can be connected in particular via the ring to an endless loop and/or endless winding.

In particular, an armature can comprise a first additively applied ring which is printed onto first end faces of the slot bars. On the opposite end face, there is preferably a second additively applied ring which is preferably printed onto second end faces of the slot bars.

The slot carrier, the armature blank or the laminate stack preferably comprises several slots which preferably extend along a circumference of the slot carrier or the laminate stack, in particular in axial direction. Slots may be arranged in different radial positions within the armature slots.

In particular, the slots run at a slot angle to the axial direction. The slot angle is preferably between 2° and 8°.

In particular, a direct and additive application of the rings to the axial ends or end faces of the slot bars is carried out. In this way, the contact resistance between the axial ends of the slot bars and the ring can be reduced or minimised, since neither welding points nor casting processes nor bending or twisting are required, and at the same time both the connection cross-section as well as the connection angle can be flexibly determined.

In this way, alternatively bends with different diameters between the slot bars can be produced.

In addition, the course of the connecting elements in the ring can be set flexibly and with low tolerances.

In particular, it becomes possible to apply the entire ring in a single work step, in particular additively, so that restrictions due to sequential application or formation of the parts of the ring are avoided.

The required installation space can be reduced or also expanded in both the axial and radial directions. Thus, with a ring or armature according to the invention, both the overall height as well as the radial thickness profile can be reduced and/or adapted to the specific requirements, in particular by means of lower tolerances and distances between the connecting elements and/or by adaptation of cross-sections.

The invention also makes it possible to increase the proportion of the active area of the armature and/or rotor in relation to its total height or total length. The active area is understood in particular to be the space within the slot carrier or laminate stack. The total length of an armature is a balance or sum of the length or height of the slot bars and the active length. The active length is understood in particular to be a length of the active area in the axial direction.

The associated electric motor or electric generator can in particular be an internal rotor, whereby the internal rotor can be designed as a passive armature. Alternatively, the associated electric motor or electric generator can be an external rotor.

The slot bars can be produced by machining, die casting, extrusion, forming processes, cutting processes, bending from raw material or directly by an additive process and/or additive manufacturing.

The slot bars preferably have two side surfaces which are essentially straight and parallel to each other and extend through the active area of the armature when installed.

The slot bars are preferably cuboid or at least essentially cuboid. Preferably, the slot bars have a length, in particular in the axial direction, which is more than twice their width, in particular in the radial direction.

Preferably, the slot bars have a width, in particular in the radial direction, which is more than twice their height, in particular in the tangential direction.

Manufacturing using an additive process allows the respective cross-section to be specifically adapted to the specific requirements. For example, the cross-section within the active area can be designed such that it essentially completely fills the respective slots or the intended part of the slots. In addition, the connection area between two slot bars can be designed with a different, for example flat, cross-section.

In one embodiment, the slot bars are inserted into the slot carrier, the armature blank or the laminate stack in such a way that they end approximately flush with an end face thereof, so that the ring can then be additively applied.

The invention also allows the cross-sections in the armature and/or rotor to be adapted very quickly to changed requirements. In particular, using the same raw material, a first armature with first electrical properties and/or cross-sections and then immediately subsequently a second armature and/or rotor with second electrical properties and/or cross-sections can be produced.

As raw materials in particular aluminium materials or aluminium powder, copper materials or copper powder, in particular pure copper, pure aluminium, aluminium alloys or copper alloys are used. The copper materials or copper powder used preferably have a purity of more than 99.5%.

High-purity copper and/or high-purity aluminium preferably offer good electrical and thermal conductivity. Preferably, the tensile strength is at least 170 MPa and/or the yield strength is at least 120 MPa and/or the elongation at break is greater than 20%.

In particular for a two-sided application of a ring by means of an additive manufacturing process, at least one of the slot bars may be designed in a U-shape (or as a U-pin). A U-shaped slot bar is understood to be a slot bar which has two parallel legs and/or whose open ends are arranged at least essentially on the same side.

In particular, the slot bars may comprise at least one conductor type, in particular different conductor types.

A first slot bar may be formed of a first conductor type and a second slot bar of a second conductor type differing from the first conductor type.

The first slot bar and the second slot bar may be introduced radially and/or axially adjacent to each other with respect to a central axis of the stator.

A slot bar may be formed in a first section of a first conductor type and in a second section adjacent to the first section in the axial/longitudinal direction of a second conductor type which differs from the first conductor type.

The first conductor type may have a first conductivity and the second conductor type a second conductivity, so that ohmic losses during operation of the electric machine are reduced by suitable variation of the conductivity.

The first conductor type may have a first cross-section/cross-sectional profile and the second conductor type may have a second cross-section/cross-sectional profile, so that thermal and/or electrical losses during operation of the electric machine are specifically reduced in sections with high current flow.

The first conductor type may have a first number of parallel strands/conductors and the second conductor type may have a second number of parallel strands/conductors, so that losses during operation of the electrical machine at high frequencies in required sections are preferably reduced.

The connecting elements may have, at least in sections, a third conductivity, cross-section/cross-sectional profile and/or number of parallel strands/conductors, so that losses during operation of the electrical machine are preferably reduced.

Alternatively or additionally, at least one of the slot bars and/or conductor types can be produced in at least one section by an additive manufacturing process, wherein in a cross-section at least one second region has a lower conductivity than at least one first region.

The second region may comprise at least one gap, intermediate space or cavity in extending transversely through the cross-section and/or longitudinally through the slot bar, in particular along a straight line and/or plane, so that the slot bar is split into at least two partial slot bars.

The (respective) second region can form at least in sections a cavity or intermediate space (preferably filled, e.g. filled with gas and/or filled with a liquid and/or solid material).

The (respective) second region can be introduced during additive manufacturing by multi-material processing, for example in such a way that the respective first region(s) are provided by supplying a first material and the respective second region(s) are provided by supplying a different material, for example with lower conductivity.

Preferably, the at least one second region (several or all second regions, if applicable) is/are electrically insulating, further preferably at least in sections formed by an electrically insulating material and/or at least in sections formed by a cavity (e.g. filled with gas or air). A cavity can result from removing build-up material that is still in powder form. For this purpose and/or for other reasons, openings can be provided, since end areas are (otherwise) possibly completely closed (in particular sintered).

The (respective) second region may result from non-exposure or a differing exposure. It may extend from one layer plane to the next layer plane in such a way that at least a certain proportion of the surface area overlaps, so that a continuous cavity (gap) is created. At least one second (several or all second, if applicable) region may extend over at least 0.5 cm of the length of the conductor (or the winding), if necessary over at least 1.0 cm or at least 2.0 cm.

The partial slot bars may only be electrically connected to each other by the ring or rings.

The conductivities of the first regions and the at least one second region to be compared should preferably be determined at a temperature of 20° C. The conductivity of at least one second region (or several or all second regions, if applicable) is preferably a maximum of 0.5 times, more preferably a maximum of 0.1 times, and even more preferably a maximum of 0.001 times or a maximum of 0.001 times as large as the electrical conductivity of at least one (or several or all, if applicable) first regions. The electrical conductivity of at least (possibly several or all) first regions is preferably at least 0.1×10⁶ S/m, further preferably at least 1.0×10⁶ S/m, further preferably at least 20×10⁶ S/m and/or at most 200×10⁶ S/m or at most 100×10⁶ S/m. The conductivity of at least one second region (several or all second regions, if applicable) may be at most 1×10⁶ S/m, if applicable at most 0.1×10⁶ S/m, further alternatively at most 1.0×10³ S/m, further alternatively at most 1.0 S/m, further alternatively at most 1.0×10⁻³ S/m, still further alternatively at most 1.0×10⁻⁶ S/m, still further alternatively at most 1.0×10⁻⁹ S/m and/or at least 1.0×10⁻²⁰ S/m, alternatively at least 1.0×10⁻¹⁵ S/m.

In one embodiment, at least two partial slot bars are stacked on top of each other in a slot. The partial slot bars preferably exchange their positions in relation to their position in the stack, i.e. in particular the top or bottom, at least once over their partial slot length.

In one embodiment, this position exchange is achieved without twisting or rotation by means of complementary step jumps of the partial groove bars, which are produced by material forming or additive manufacturing. In order to realise a compact structure, the cross-sectional shapes of the partial groove bars preferably vary in the region of the step jumps.

A conductor type can be, in particular, solid copper or a hollow conductor. Alternatively or additionally, at least one of the slot bars can be made of solid copper and/or as a hollow conductor in at least one section, wherein the slot bar can be made, in particular, of a single copper core extending along a longitudinal direction, in particular with a (circular) round and/or flat and/or rectangular cross-section and/or as flat wire and/or with an outer diameter of at least 1.0 mm and/or with an inner diameter of at least 0.5 mm.

In embodiments, only one ring can be realised by additive application (manufacturing). Alternatively, both rings can also be produced at least in sections by additive application, in particular by layer-by-layer application of a build-up material and additive solidification of the build-up material by irradiation with at least one beam impinging on the build-up material.

In embodiments, only one slot bar (in particular in the case of U-shaped slot bars) can be realised by additive application (manufacture). Alternatively, all slot bars can also be produced at least in sections by additive application, in particular by layer-by-layer application of a build-up material and additive solidification of the build-up material by irradiation with at least one beam impinging on the build-up material, in particular in the case of I-shaped slot bars.

In one embodiment, the rings have a protrusion in the axial direction of at least 5 mm, preferably at least 10 mm, and more preferably at least 20 mm, relative to the armature blank or laminate stack.

In general, the slot bars can be produced by drawing and/or forming blanks, which may be drawn, and/or by an additive manufacturing process. Combinations are also conceivable in which the slot bars are produced partly by forming a blank and partly by an additive manufacturing process. It is also conceivable that at least one slot bar is produced by (conventional) forming and at least one slot bar by an additive manufacturing process.

In one embodiment, a slot bar has a changing cross-section. For example, the cross-section can increase (at least in sections) and/or decrease (at least in sections) and/or change its shape (at least in sections). Particularly preferably a cross-sectional area remains constant, whereby the shape of the cross-section changes. Alternatively, a cross-sectional shape can remain constant, whereby the cross-sectional area changes. Further alternatively, both the cross-sectional area and the cross-sectional shape can change. In particular, this allows space to be gained between the individual conductor sections, so that, for example, less forming work is required. The dimensions of the conductor (or of the winding as a whole) can thus be advantageously adjusted.

In one embodiment, several at least essentially identical armature blanks can be produced, which are provided with different rings. By this different armature structures or armature types can be produced in a comparatively simple manner, which are preferably optimised for specific applications.

The ends of the slot bars can be levelled (or brought to a common plane) before additive application, in particular by milling, and/or be cleaned. This allows a subsequent additive application of the ring or rings in a particularly simple manner.

A position and/or extension or shape of ends of the slot bars can possibly be determined before additive application by means of a, e.g. optical, measuring device. This enables a precise additive manufacturing process in a simple manner.

The above-mentioned object is further solved in particular by an, in particular rotating, electric machine, in particular an electric motor or generator, comprising a armature or rotor according to the invention.

In one embodiment, the electric machine is an asynchronous machine, in particular an asynchronous electric motor or asynchronous generator.

In one embodiment, the armature or rotor forms the rotating part, in particular the entire rotating part, of the electric machine.

Further embodiments arise from the dependent claims.

In the following, the invention is described with reference to exemplary embodiments, which are explained in more detail with reference to the figures. Hereby show:

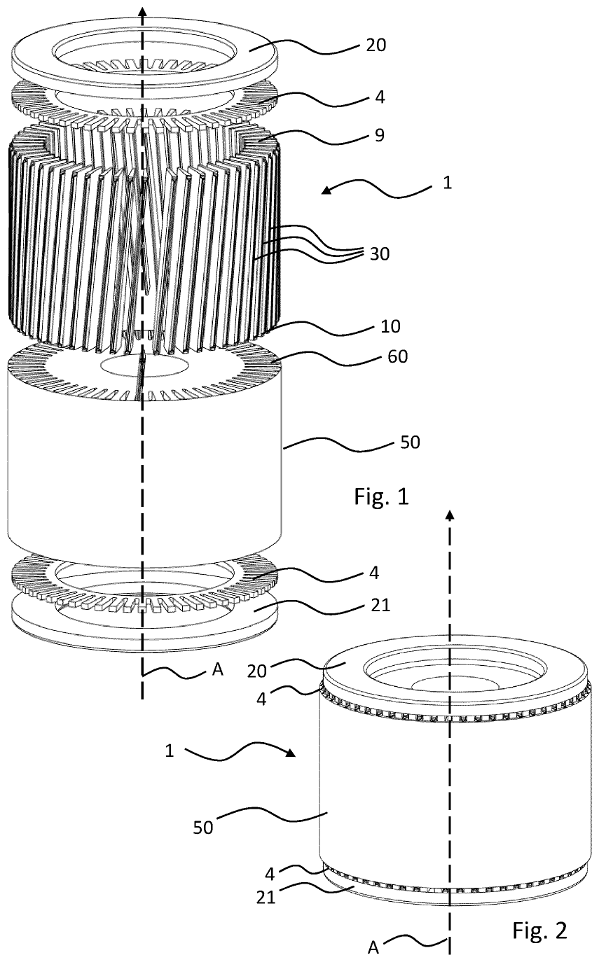

FIG. 1 a schematic view of an embodiment of an armature and/or rotor in an exploded view;

FIG. 2 a schematic view of an embodiment of an armature and/or rotor;

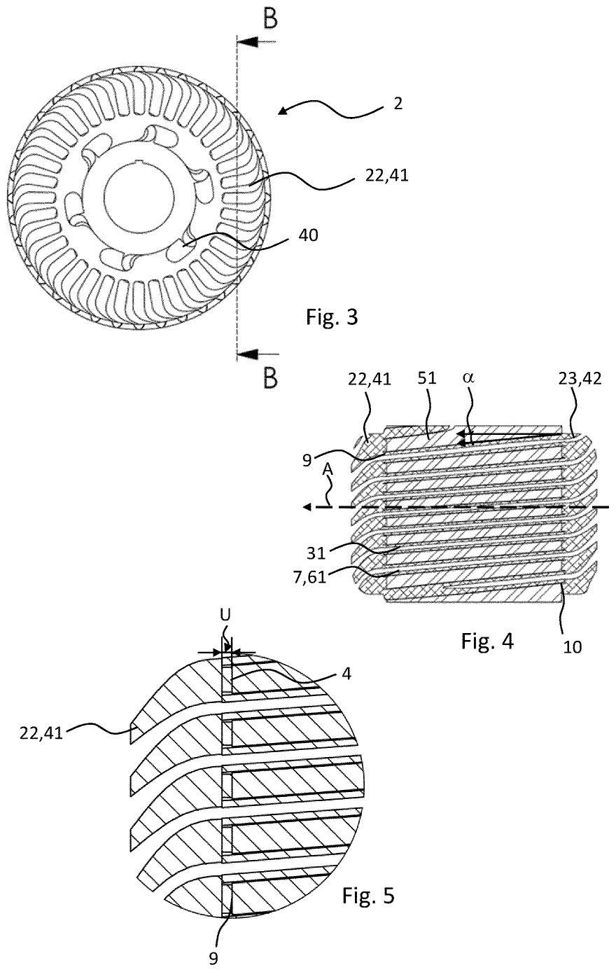

FIG. 3 a top view of an armature and/or rotor;

FIG. 4 a cross-section of an armature and/or rotor;

FIG. 5 a partial cross-section of an armature and/or rotor;

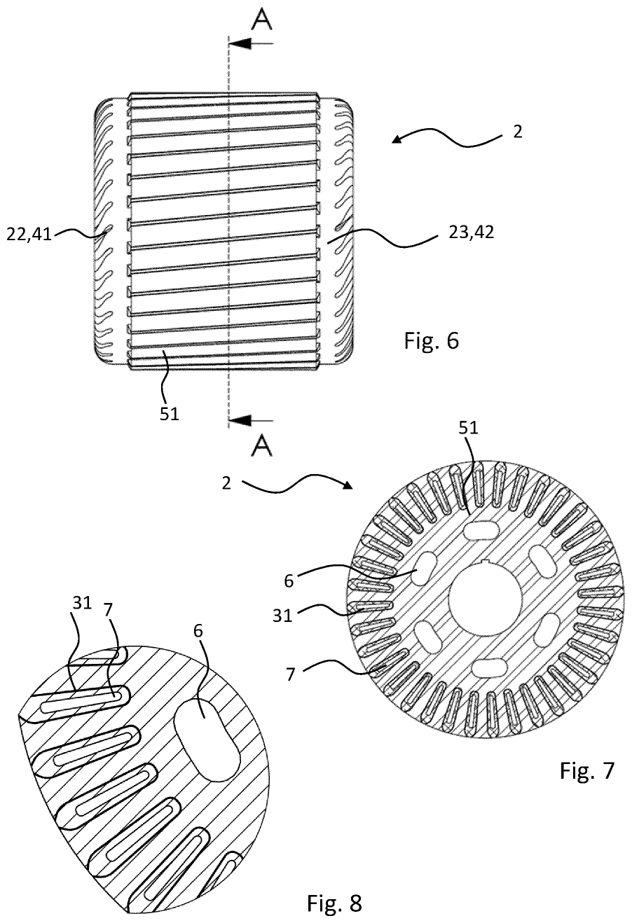

FIG. 6 a side view of an armature and/or rotor;

FIG. 7 a cross-section of an armature and/or rotor;

FIG. 8 a partial cross-section of an armature and/or rotor;

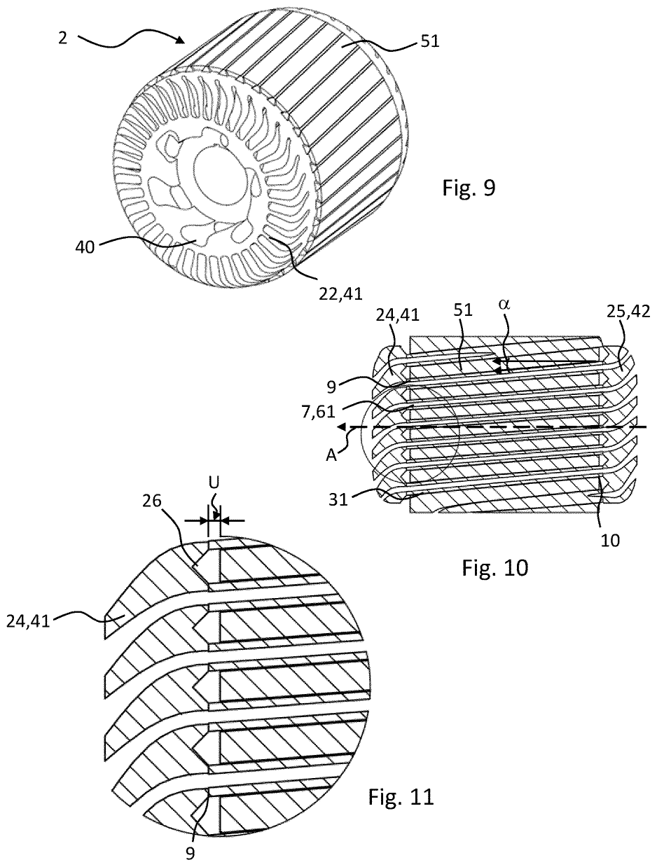

FIG. 9 a schematic view of an embodiment of an armature and/or rotor;

FIG. 10 a cross-section of an armature and/or rotor;

FIG. 11 a partial cross-section of an armature and/or rotor;

FIG. 12 a side view of an armature and/or rotor;

FIG. 13 a schematic view of an embodiment of an armature and/or rotor in exploded view, as well as

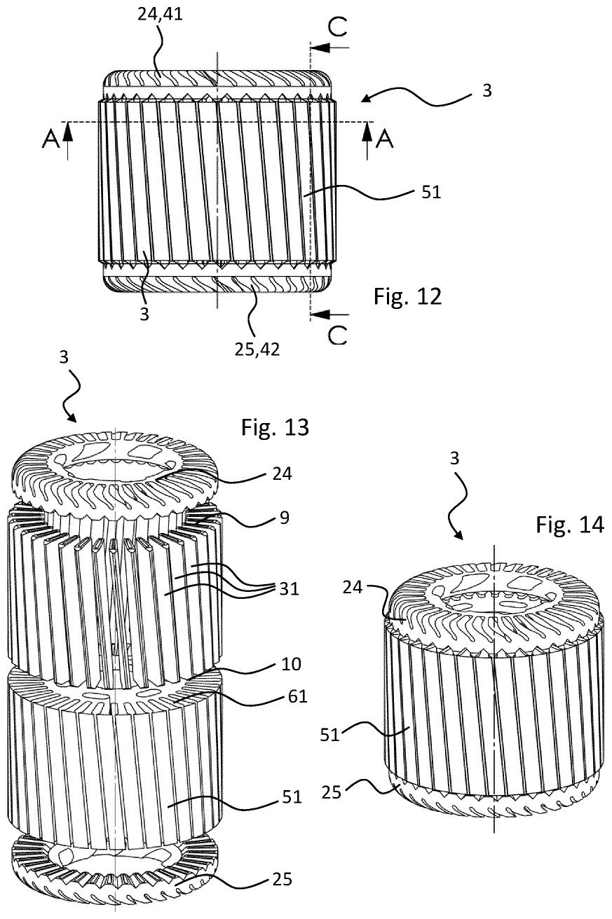

FIG. 14 a schematic view of an embodiment of an armature and/or rotor.

In the following description, the same reference numbers are used for identical and similarly functioning parts.

FIGS. 1 to 14 show armatures and/or rotors 1, 2, 3, in particular short-circuit or cage rotors, for an electric machine, in particular manufactured according to a method according to the invention, comprising a laminate stack 50, 51.

Slot bars 30, 31 are inserted into the laminate stack 50, 51 in such a way that the slot bars 30, 31 have a protrusion beyond the laminate stack 50, 51 at at least one of their end faces 9, 10.

The slot bars 30, 31 can be inserted into the laminate stack 50, 51 in particular in such a way that the slot bars 30, 31 have protrusions U beyond the laminate stack 50, 51 at the height of inserts 4 attached to end faces 9 of the laminate stack.

The inserts 4 are joined to the laminate stack 50, 51, in particular by means of a temperature-stable adhesive.

In particular, essentially flat surfaces are produced between the end faces 9, 10 of the slot bars 30, 31 and a surface of an insert 4 each.

The essentially flat surfaces are preferably produced by machining and/or precision manufacturing of the laminate stack 50, 51, inserts 4 and slot bars 30, 31.

Rings 20 and 21, 22 and 23 or 24 and 25, preferably short-circuit rings, are printed onto the end faces of the slot bars 30, 31, in particular by means of an additive printing process.

Alternatively, the slot bars 30, 31 can also be flush with the laminate stack 50, 51. In this case, inserts are not used.

The rings 20 to 25 are printed directly onto the laminate stack 50, 51 and/or the slot bars 30, 31.

The rings 20 to 25 are printed on their undersides either flush or in the form of arcs and/or bridges 26 between end faces 9, 10 of the slot bars 30, 31 to the laminate stack 50, 51 and/or the slot bars 30, 31.

According to FIGS. 1 to 14, a first ring 20, 22, 24 is applied to first end faces 9 of the slot bars 30, 31 and a second ring 21, 23, 25 is applied to second end faces 10 of the slot bars 30, 31 opposite the first end faces.

The rings 22, 23, 24, 25 according to FIGS. 4 to 14 comprise blades 40, 41, 42 for putting a coolant into circulation, which extend from an outer circumference of the ring 22, 23, 24, 25 to an inner circumference, in particular arcuate/curved from the outer circumference of the ring to an inner circumference.

The blades 40, 41, 42 each have curvatures in the axial direction A and in the radial direction.

An axial direction A is understood in particular to mean a direction parallel to the axis of rotation of the armature and/or rotor 1, 2, 3.

First cooling channels 6 extend through the laminate stack 50, 51, as shown in FIG. 7 and FIG. 8. The cooling channels 6 extend axially through the laminate stack 50, 51 with a preferably constant cross-section.

In particular, the first cooling channels 6 run at a slot angle a to the axial direction A. The groove angle is preferably between 2° and 8°.

In particular, the first cooling channels 6 are arranged next to each other in the circumferential direction, preferably at equal distances from each other.

Second cooling channels 7 extend in particular in a straight line through the slot bars 31. The cooling channels 7 extend in each case in the longitudinal direction through the slot bars 31 from a first end face to a second end face opposite the first end face. The cooling channels 7 also extend in the slot bars 31 in each case in the radial direction from an inner region to an outer region of the slot bar 31.

In particular, the second cooling channels 7 run at a slot angle a to the axial direction. Preferably, the slot angle is between 2° and 8°.

In particular, the second cooling channels 7 are arranged radially outside the first cooling channels 6.

In a cross-section, the slot bars 31 comprise a circumferential web region which surrounds the cooling channel. Preferably, the web region has an at least essentially constant thickness on at least two, more preferably at least three sides.

The blades 40 to 42 are printed onto the slot bars 31 in such a way that the cooling channels 6, 7 continue through, at and/or between the blades 40, 41, 42 in the axial direction A.

The cross-section of the cooling channels in the blades 40 to 42 is identical or at least essentially identical to the cross-sections of the cooling channels 6, 7 in the slot bars 31 in the additively applied, in particular printed, region.

The cooling channels in the region of the blades 40 to 42 have a cross-section that is constant at least in sections and/or a radius that is constant at least in sections.

Preferably, the second cooling channels 7 extend in a straight line through the slot bars 31 and continue in a curved manner in the region of the ring 22, 24 as well as the ring 23, 25.

Preferably, the blades 41, 42 are curved in the region of the first ring 22, 24 in the direction to a first side, in particular in the direction of rotation, and in the region of the second ring 23, 25 in the direction to a second side opposite to the first side, in particular in the opposite direction of rotation.

Preferably, the coolant flows through the first cooling channels 6 in a first direction and through the second cooling channels 7 in a second direction opposite to the first direction.

Preferably, the blades 40 of the first cooling channels 6 are arranged such that they convey the coolant in a first direction and the blades 41, 42 of the second cooling channels 7 are arranged such that they convey the coolant in a second direction opposite to the first direction.

In one embodiment, the rings 20 to 25 may comprise at least one sensor for determining the position, in particular of a rotational angle of the armature and/or rotor 1, 2, 3.

According to the invention, a method for manufacturing an armature and/or rotor 1, 2, 3, in particular a short-circuit or cage rotor, for an electric machine is also provided. The method comprises the method steps
inserting slot bars 30, 31, produced in particular by an additive method, machining or die casting, into slots 60, 61, in particular extending in an axial direction A, of a laminate stack 50, 51, so that the slot bars 30, 31 have a protrusion U beyond the laminate stack 50, 51 at at least one of their end faces 9, 10, in particular at the height of at least one insert 4, or are flush with the laminate stack 50, 51,
additively applying, in particular printing, of at least one ring 20-25, preferably a short-circuit ring, to at least one of the end faces of the slot bars 30, 31, in particular by means of an additive printing process.

### The Method According to the Invention Comprises in Particular the Method Steps

inserting slot bars 30, 31, produced in particular by an additive method, machining or die casting, into slots 60, 61, in particular extending in an axial direction A, of a laminate stack 50, 51, so that the slot bars 30, 31 have a protrusion U beyond the laminate stack 50, 51 at least at one of their end faces 9, 10, in particular at the height of at least one insert 4, or are flush with the laminate stack 50, 51,
attaching the at least one insert 4 on an end face of the laminate stack 50, 51, in particular as a joining aid and/or for thermal and/or electrical insulation,
joining the at least one insert 4, in particular by means of a temperature-stable adhesive, to the laminate stack 50, 51, wherein in particular at least one essentially flat surface is produced between an end face of the slot bars 30 and a surface of the at least one insert 4, wherein the at least one essentially flat surface is preferably produced by machining and/or precision manufacturing of the laminate stack 50, 51, insert 4 and slot bars 30, 31,
additively applying, in particular printing, of at least one ring 20-25, preferably a short-circuit ring, to the at least one of the end faces of the slot bars 30, 31, in particular by means of an additive printing process.

In one embodiment, the armature and/or rotor 1, 2, 3 is manufactured in a three-stage process comprising the process steps
inserting slot bars 30, 31, produced in particular by an additive process, machining or die casting, into slots 60, 61, in particular extending in an axial direction A, of a laminate stack 50 51, so that the slot bars 30, 31 have a protrusion U beyond the laminate stack 50, 51 at both end faces 9, 10, in particular at the height of two inserts 4, or are flush with the laminate stack 50,51,
additively applying, in particular printing, of a first ring 20, 22, 24, preferably a short-circuit ring, to a first end face 9 of the slot bars 30, 31, in particular by means of an additive printing process,
additively applying, in particular printing, of a second ring 21, 23, 25, preferably a short-circuit ring, on a second end face 10 of the slot bars 30, 31 opposite the first end face 9, in particular by means of an additive printing process.

Preferably, the slot bars 30, 31 and/or the at least one ring 20 to 25 are free of pores and/or cavities. In particular, the slot bars 30, 31 and/or the at least one ring 20 to have a porosity or residual porosity of less than 0.1%.

In particular, the slot bars 30, 31 and/or the at least one ring 20 to 25 have a porosity or residual porosity in a range from 0.01% to 0.1%.

At this point, it should be noted that all parts described above, considered individually and in any combination, in particular the details shown in the drawings, are claimed as essential to the invention. Modifications thereof are familiar to those skilled in the art.

Furthermore, it should be noted that the broadest possible scope of protection is sought. In this respect, the invention defined in the claims may also be specified by features described by further features (even if these further features are not necessarily to be included). It is explicitly pointed out that round brackets and the term ‘in particular’ are intended to emphasise the optional nature of features in the respective context (which does not mean, conversely, that a feature is to be regarded as mandatory in the corresponding context without such indication).

### REFERENCE SIGNS

1, 2,3 armature and/or rotor
4 insert
6, 7 cooling channels
9,10 end faces
20-25 rings
26 bridges
30, 31 slot bars
40-42 blades
50,51 laminate stack
60,61 slots
A axial direction
U protrusion
a slot angle

1. Method for manufacturing an armature and/or rotor for an electric machine, comprising:
inserting slot bars into slots of a laminate stack so that the slot bars have a protrusion beyond the laminate stack at at least one of their end faces; and
additively applying at least one ring to at least one of the end faces of the slot bars.

2. Method for manufacturing an armature and/or rotor for an electric machine, comprising:
inserting slot bars into slots of a laminate stack such that the slot bars have a protrusion beyond the laminate stack at at least one of their end faces;
attaching at least one insert to an end face of the laminate stack;
joining the at least one to the laminate stack, wherein at least one essentially flat surface is produced between an end face of the slot bars and a surface of the at least one insert; and
additively applying at least one ring to the at least one of the end faces of the slot bars.

3. Method according to claim 1, wherein a first ring is applied to first end faces of the slot bars and a second ring is applied to second end faces of the slot bars opposite the first end faces.

4. Method according to claim 1, wherein the slot bars and/or the at least one ring have a residual porosity in a range from 0.01% to 0.1%.

5. Method according to claim 1, wherein between the slot bars and the laminate stack, at least one at least partially circumferential, air gap and/or air inclusion is arranged and/or wherein air gaps and/or air inclusions extend at least partially around the inserted slot bars to the laminate stack.

6. Method according to claim 1, wherein between the slot bars and the laminate stack, no full-surface contact is established and/or wherein the at least one circumferential air gap and/or air inclusion has an insulating effect and/or reduces electrical losses.

7. Armature and/or rotor manufactured according to a method according to claim 1,
wherein the slot bars are inserted into the laminate stack in such a way that the slot bars have a protrusion beyond the laminate stack at at least one of their end faces, at the height of at least one insert which is attached or can be attached to an end face of the laminate stack, or are flush with the laminate stack.

8. Armature and/or rotor manufactured according to the method of claim 1,
wherein the slot bars are inserted into the laminate stack in such a way that the slot bars have a protrusion beyond the laminate stack at the height of at least one insert attached to an end face of the laminate stack,
wherein the at least one insert is joined to the laminate stack, by means of a temperature-stable adhesive, wherein at least one essentially flat surface is produced between an end face of the slot bars and a surface of the at least one insert, wherein the at least one essentially flat surface is produced by machining and/or precision manufacturing of the laminate stack, insert and slot bars.

9. Armature and/or rotor according to claim 7, wherein a first ring is applied to first end faces of the slot bars and a second ring is applied to second end faces of the slot bars opposite the first end faces.

10. Armature and/or rotor, according to claim 7,
wherein the at least one ring is additively printed, directly onto the laminate stack and/or the slot bars and/or
wherein the at least one ring is printed on the laminate stack and/or the slot bars on its underside flush or in the form of arcs and/or bridges between end faces of the slot bars.

11. Armature and/or rotor according to claim 7, wherein the ring comprises blades for putting a coolant into circulation, which extend in an arcuate/curved manner from an outer circumference of the ring to an inner circumference.

12. Armature and/or rotor according to claim 7, wherein the blades have a curvature in the axial and/or radial direction.

13. Armature and/or rotor according to claim 7, wherein first cooling channels extend through the laminate stack and/or wherein second cooling channels extend through the slot bars.

14. Armature and/or rotor according to claim 7, wherein the blades are printed onto the slot bars in such a way that the cooling channels continue through, at or between the blades in the axial direction.

15. Armature and/or rotor according to claim 7, wherein the ring comprises at least one sensor for determining a rotational angle of the armature and/or rotor.

16. Armature and/or rotor according to claim 7, wherein the slot bars and/or the at least one ring have a porosity or residual porosity in a range from 0.01% to 0.1%.

17. Electrical machine with at least one armature or rotor according to claim 7.
